(19) United States
(12) Patent Application Publication
(10) Pub. No.: US 2015/0056869 A1
(43) Pub. Date: Feb. 26, 2015

(54) ELECTRIC CONNECTOR

(71) Applicant: ACES ELECTRONICS CO., LTD., Zhongli City (TW)

(72) Inventor: Norio YOSHIDA, Atsugi-Shi (JP)

(73) Assignee: ACES ELECTRONICS CO., LTD., Zhongli City (TW)

(21) Appl. No.: 14/459,448

(22) Filed: Aug. 14, 2014

(30) Foreign Application Priority Data
Aug. 21, 2013 (JP) 2013-171060

(51) Int. Cl. H01R 12/75

(52) U.S. Cl. CPC H01R 12/75
USPC 439/694

(57) ABSTRACT

An electric connector includes a first connector, and a second connector, wherein the first connector includes a first housing, a plurality of first contacts, and first lock metal fittings, the second connector includes a second housing, a plurality of second contacts, and a second lock metal fitting, an electric wires are inserted into the second connector in a direction parallel to a circuit board surface, and in a direction perpendicular to an arranging direction of the second contacts, and the second lock metal fitting includes lock engaging portions provided at both ends of the arranging direction of the second contacts of the second housing, and a coupling portion coupling the lock engaging portions at least at a side of a removing direction of the second connector of the electric wires at an insertion side of the electric wires of the second housing.

### CROSS-REFERENCE TO RELATED APPLICATIONS

This application claims priority to Japanese Patent Application No. 2013-171060, filed on Aug. 21, 2013, which is incorporated herein by reference in its entirety.

### BACKGROUND OF THE INVENTION

The present invention relates to an electric connector that connects an electric wire and a board.

Typically, there are electric connectors including a base connector including a resin housing mounted on a circuit board, and a socket connector including a resin housing fit into the base connector in a direction perpendicular to the circuit board (e.g., see JP 2006-128033 A). According to the electric connectors, the socket connector can be locked in the base connector by use of friction between the housings.

However, in the above electric connectors, the housings are made of a resin, and thus the housings are worn away due to repetitive insertion and removal of the connectors, and lock strength becomes weak.

### SUMMARY OF THE INVENTION

An objective of the present invention is to provide an electric connector having large lock strength.

An electric connector of the present invention includes a first connector mounted on a circuit board surface, and a second connector connected to electric wires, wherein the first connector includes a first housing including an insertion portion into which the second connector is inserted from a direction perpendicular to the circuit board surface, a plurality of first contacts arranged in the insertion portion, and first lock metal fittings provided at both ends of an arranging direction of the first contacts of the first housing, having elasticity, and preventing removal of the second connector, the second connector includes a second housing inserted into the insertion portion of the first connector, a plurality of second contacts connected to the plurality of first contacts, and a second lock metal fitting engaged with the first lock metal fittings, the electric wires are inserted into the second connector in a direction parallel to the circuit board surface, and in a direction perpendicular to an arranging direction of the second contacts, and the second lock metal fitting includes lock engaging portions provided at both ends of the arranging direction of the second contacts of the second housing, and a coupling portion coupling the lock engaging portions at least at a side of a removing direction of the second connector of the electric wires at an insertion side of the electric wires of the second housing.

Further, the electric connector of the present invention may have the coupling portion include openings into which the electric wires are inserted.

Further, the electric connector of the present invention may have the second lock metal fitting insert-molded into the second housing.

According to the present invention, an electric connector having large lock strength can be provided.

### BRIEF DESCRIPTION OF THE DRAWINGS

FIG. 1 is a perspective view of an electric connector according to an embodiment;

FIG. 2 is a perspective view of an electric wire-side connector according to the embodiment;

FIG. 3 is a perspective view of the electric wire-side connector according to the embodiment;

FIG. 4 is a perspective view of an electric wire-side lock metal fitting according to the embodiment;

FIG. 5 is a perspective view of a board-side connector according to the embodiment;

FIG. 6 is a perspective view indicating a state in which the electric wire-side connector and the board-side connector according to the embodiment are fit; and

FIG. 7 is a cross sectional view indicating a state in which the electric wire-side connector and the board-side connector according to the embodiment are fit.

### DETAILED DESCRIPTION

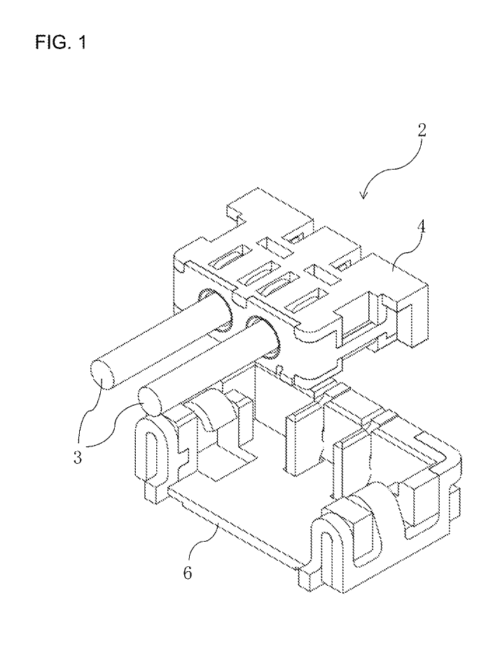

An electric connector according to an embodiment of the present invention will be herein described with reference to the drawings. FIG. 1 is a perspective view of an electric connector according to an embodiment. As illustrated in FIG. 1, an electric connector 2 includes an electric wire-side connector 4 connected to electric wires 3, and a board-side connector 6 mounted on a circuit board surface (not illustrated).

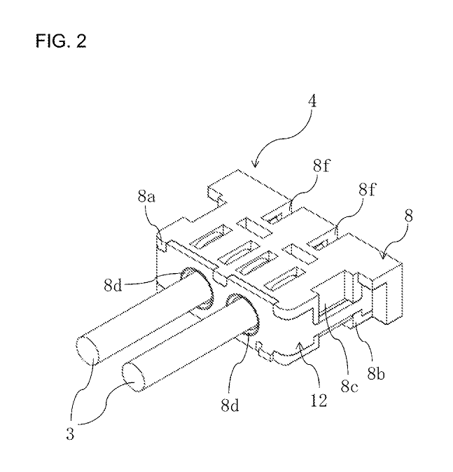

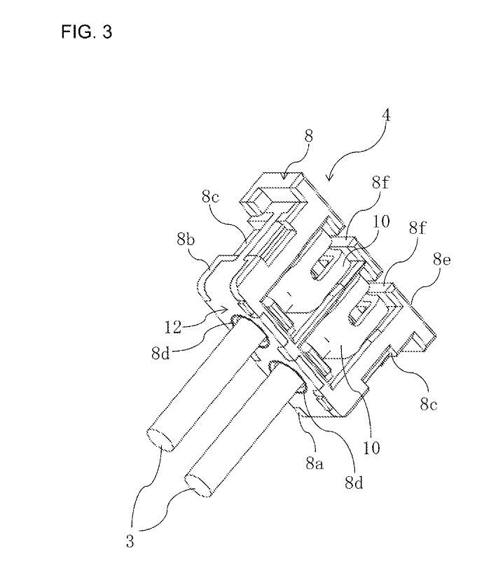

FIG. 2 is a perspective view of the electric wire-side connector 4 as viewed from above, and FIG. 3 is a perspective view of the electric wire-side connector 4 as viewed from below. As illustrated in FIGS. 2 and 3, the electric wire-side connector 4 includes a rectangular parallelepiped housing 8 inserted into the board-side connector 6 in a direction (hereinafter, referred to as board perpendicular direction) perpendicular to the circuit board surface. Here, the housing 8 is formed of a resin member having insulation properties.

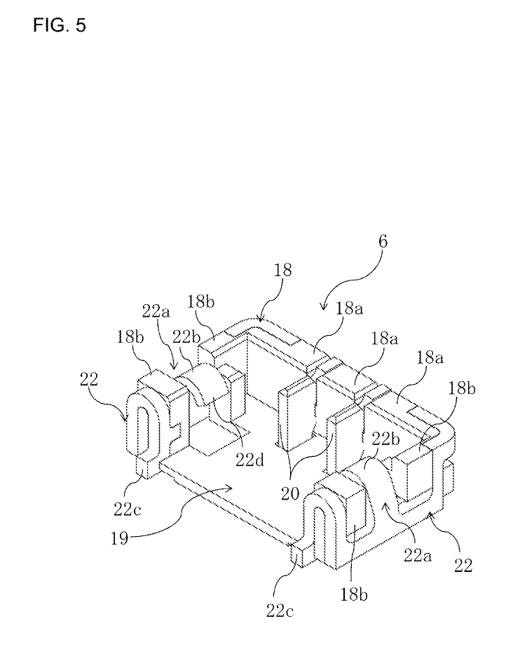

Further, a plurality of electric wire-side contacts 10, which is electrically connected to board-side contacts 20 (see FIG. 5) when the electric wire-side connector 4 is fit into the board-side connector 6, is arranged inside the housing 8. Further, an electric wire-side lock metal fitting 12 to be engaged with board-side lock metal fittings 22 (see FIG. 5) is insert-molded into the housing 8.

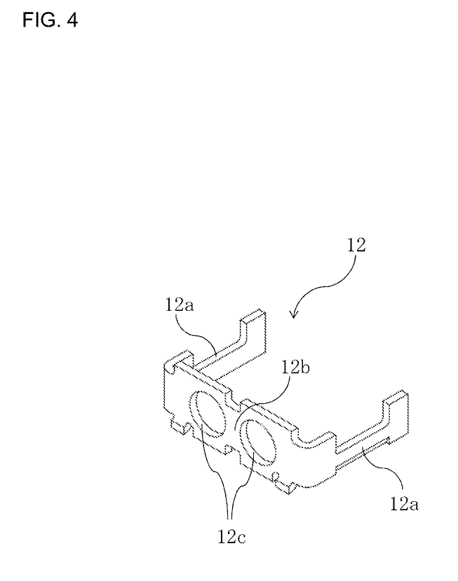

FIG. 4 is a perspective view illustrating the electric wire-side lock metal fitting 12. As illustrated in FIG. 4, the electric wire-side lock metal fitting 12 is provided with lock engaging portions 12a positioned at both end portions 8b of an arranging direction (hereinafter, referred to as contact arranging direction) of the electric wire-side contacts 10 of the housing 8, and for engaging the board-side lock metal fittings 22. Further, the electric wire-side lock metal fitting 12 is provided with a coupling portion 12b positioned at an end portion 8a of a side (hereinafter, referred to as electric wire insertion-side) into which the electric wires 3 of the housing 8 are inserted, and for coupling the lock engaging portions 12a. Further, openings 12c for allowing the electric wires 3 to be inserted are formed in the coupling portion 12b.

Further, grooves 8c extending in the board perpendicular direction are formed in the both end portions 8b of the housing 8. The lock engaging portions 12a of the electric wire-side lock metal fitting 12 are exposed at the grooves 8c. Further, openings 8d for allowing the electric wires 3 to be inserted, the electric wires 3 being connected to the electric wire-side contacts 10, are formed in the end portion 8a of the housing 8. Further, notched portions 8f into which the board-side contacts 20 are fit are formed in an end portion 8e at a side opposite to the end portion 8a of the housing 8.

FIG. 5 is a perspective view of the board-side connector 6. As illustrated in FIG. 5, the board-side connector 6 includes a rectangular parallelepiped housing 18 made of a resin member having insulation properties. Here, a square insertion recessed portion 19 for accepting the electric wire-side connector 4 inserted from the board perpendicular direction is formed in the housing 18. The insertion recessed portion 19 is a recessed space surrounded by a wall portion 18a formed at a side opposite to the electric wire insertion-side, and a pair of wall portions 18b formed at both end portions of the contact arranging direction.

Further, a plurality of the flat plate type board-side contacts 20 is arranged in the insertion recessed portion 19. Further, the board-side lock metal fittings 22 for preventing removal of the electric wire-side connector 4 from the board-side connector 6 are insert-molded into the housing 18.

Here, engaging portions 22a positioned at the pair of wall portions 18b, respectively, and engaged with the lock engaging portions 12a of the electric wire-side lock metal fitting 12 are provided in the board-side lock metal fittings 22. Bending portions 22b bending toward the insertion recessed portion 19 and having elasticity are provided at upper ends of the engaging portions 22a. Further, fixing portions 22c for fixing the board-side lock metal fittings 22 to the circuit board is provided at a side of the circuit board surface of the board-side lock metal fittings 22.

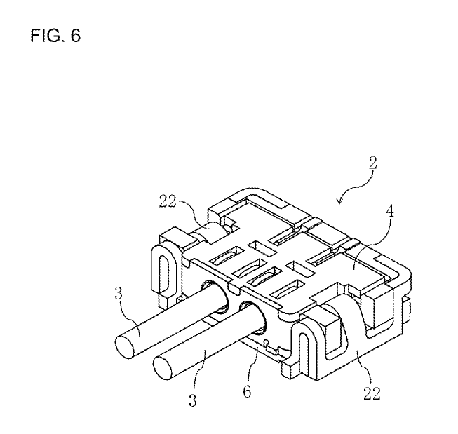

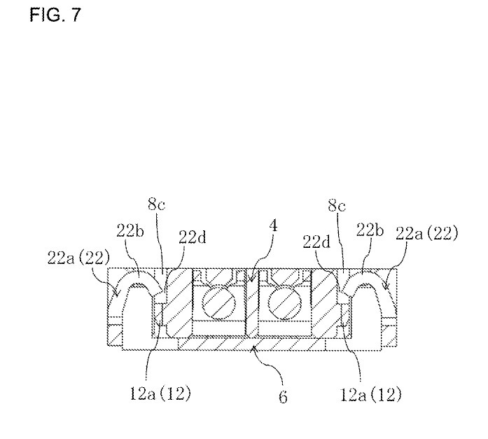

FIG. 6 is a perspective view illustrating a state in which the electric wire-side connector 4 and the board-side connector 6 according to an embodiment are fit, and FIG. 7 is a diagram illustrating a cross section of the state. When the electric wire-side connector 4 is inserted into the insertion recessed portion 19 of the board-side connector 6, and the electric wire-side connector 4 is pressed downward, lower surfaces of the lock engaging portions 12a come in contact with upper surfaces of the bending portions 22b. When the electric wire-side connector 4 is further pressed down, the bending portions 22b are pressed and extended in outer side directions of the insertion recessed portion 19, and the lock engaging portions 12a are moved to lower sides of tip portions 22d of the bending portions 22b. In this case, the tip portions 22d are returned inside the insertion recessed portion 19 due to elastic force of the bending portions 22b, and the tip portions 22d becomes in a state of being positioned at upper sides of the lock engaging portions 12a.

Accordingly, upper surfaces of the lock engaging portions 12a are engaged with the tip portions 22d of the bending portions 22b, and the electric wire-side connector 4 is locked with the board-side connector 6. Therefore, removal of the electric wire-side connector 4 from the board-side connector 6 can be prevented.

According to the electric connector 2 of the embodiment, the electric wire-side connector 4 includes the electric wire-side lock metal fitting 12, and the board-side connector 6 includes the board-side lock metal fittings 22. When the electric wire-side connector 4 is fit into the board-side connector 6, the upper surfaces of the lock engaging portions 12a are engaged with the tip portions 22d of the bending portions 22b, and thus the lock intensity of the electric connector 2 can be improved.

Further, the electric wire-side lock metal fitting 12 and the board-side lock metal fittings 22 are formed of metal. Therefore, even if insertion and removal of the electric connector 2 is repeated, these fittings are not worn away, and can maintain the lock intensity of the electric connector 2 through a long period of time.

Further, the electric wires 3 are inserted into the openings 12c of the electric wire-side lock metal fitting 12, and the end portion 8a of the housing 8 is protected by the electric wire-side lock metal fitting 12. Therefore, when the electric wires 3 are pulled and the electric wire-side connector 4 is taken out from the board-side connector 6, breakage of the housing 8 due to the electric wires 3 can be prevented.

Note that, in the above-described embodiment, the openings 12c that allow the electric wires 3 to be inserted are formed in the coupling portion 12b of the electric wire-side lock metal fitting 12. However, the coupling portion of the electric wire-side lock metal fitting may have a shape to couple both-side lock engaging portions at an upper side than the electric wires 3.

The above-described embodiment is provided for easy understanding of the invention and thus is not construed to limit the invention. Accordingly, each element disclosed in the above embodiment includes design modifications and equivalents within the technical scope of the invention.

1. An electric connector comprising:
a first connector mounted on a circuit board surface; and
a second connector connected to electric wires, wherein
the first connector includes
a first housing including an insertion portion into which the second connector is inserted from a direction perpendicular to the circuit board surface,
a plurality of first contacts arranged in the insertion portion, and
first lock metal fittings provided at both ends of an arranging direction of the first contacts of the first housing, having elasticity, and preventing removal of the second connector,
the second connector includes
a second housing inserted into the insertion portion of the first connector,
a plurality of second contacts connected to the plurality of first contacts, and
a second lock metal fitting engaged with the first lock metal fittings,
the electric wires are inserted into the second connector in a direction parallel to the circuit board surface, and in a direction perpendicular to an arranging direction of the second contacts, and
the second lock metal fitting includes lock engaging portions provided at both ends of the arranging direction of the second contacts of the second housing, and a coupling portion coupling the lock engaging portions at least at a side of a removing direction of the second connector of the electric wires at an insertion side of the electric wires of the second housing.

2. The electric connector according to claim 1, wherein the coupling portion includes openings into which the electric wires are inserted.

3. The electric connector according to claim 1, wherein the second lock metal fitting is insert-molded into the second housing.

4. The electric connector according to claim 2, wherein the second lock metal fitting is insert-molded into the second housing.
